(19) United States
(12) Patent Application Publication
(10) Pub. No.: US 2017/0034524 A1
(43) Pub. Date: Feb. 2, 2017

(54) Method and Apparatus for Sign Data Hiding of Video and Image Data

(71) Applicant: MEDIATEK INC., Hsin-Chu (TW)

(72) Inventors: Kun-Bin Lee, Taipei City (TW); Ting-An Lin, Hsinchu City (TW); Tung-Hsing Wu, Chiayi City (TW)

(21) Appl. No.: 15/292,149

(22) Filed: Oct. 13, 2016

Related U.S. Application Data
(62) Division of application No. 14/011,002, filed on Aug. 27, 2013.
(60) Provisional application No. 61/725,678, filed on Nov. 13, 2012.

(51) Int. Cl. H04N 19/48; H04N 19/60; H04N 19/124

(52) U.S. Cl. CPC H04N 19/48; H04N 19/124; H04N 19/60

(57) ABSTRACT

A method and apparatus for processing transform coefficients for a video coder or encoder is disclosed in the present invention. Embodiments according to the present invention reduce the storage requirement for sign bit hiding (SBH), improve the parallelism of SBH processing or simplify parity checking. Partial quantized transform coefficients (QTCs) of a transform block may be processed before all QTCs of the transform block are received. Zero and non-zero QTCs of a scan block may be processed concurrently and the QTCs of multiple scan blocks in a transform block may also be processed concurrently when computing cost function for SBH compensation. The range for searching for a value-modification QTC may be less than the scan block to be processed. Parity checking on QTCs may be based on least significant bits (LSBs) of all QTCs or all non-zero QTCs of a scan block.

### CROSS REFERENCE TO RELATED APPLICATION

This is a divisional application of the U.S. patent application Ser. No. 14/011,002 (filed on Aug. 27, 2013), which claims the benefit of U.S. provisional application No. 61/725,678 (filed on Nov. 13, 2012). The U.S. patent application Ser. No. 14/011,002 and the U.S. provisional application No. 61/725,678 are hereby incorporated by reference in their entirety.

### FIELD OF THE INVENTION

The present invention relates to video coding or image processing. In particular, the present invention relates to video coding or image processing techniques associated with sign data hiding (or sign bit hiding).

### BACKGROUND AND RELATED ART

Compression of digital video signals or images for transmission and storage has been a widely adopted practice in various video coding or image processing system and applications, including H.264/MPEG-4 AVC and High Efficiency Video Coding (HEVC). Various technologies have been developed to improve the performance of data compression and encoding, including the adoption of transformation like Discrete Cosine Transform (DCT). These technologies help to convert video signals or image data into coefficients that represent the video contents or image contents more efficiently.

In HEVC, a new coding tool called sign data hiding or sign bit hiding (hereinafter SBH in the present invention), is introduced to further improve compression performance of video coding. SBH can improve coding gain by optionally coding the sign bit of the first non-zero quantized transform coefficient (hereinafter referred as QTC) of a 4×4 block. If there are at least two non-zero QTCs in a 4×4 block and the distance between the scan position of the first non-zero QTC and the last non-zero QTC is greater than a preset threshold, the sign bit of the first non-zero QTC is hidden in the encoder side. While on the decoder side, the hidden bit can be inferred from checking the parity of the sum of the QTC amplitude. It is necessary to optionally compensate for the hidden sign bit in the case when the parity would not otherwise indicate the correct sign of the first non-zero QTC. This is achieved at the encoder side by selecting one QTC as a value-modification QTC and modifying its value to an adjacent value either greater or less than the former value. The amplitude close to the boundary of a quantization interval can be selected for this compensation. SBH can be implemented at a lower cost by giving the encoder the freedom to choose which QTC amplitude to use for compensation that has the lowest rate-distortion cost.

To simplify the system complexity and increase the parallelism of implementation, a video frame is usually divided into multiple blocks for video transformation and data encoding. For example, an 8×8 block can be used for transform while the output can be further divided into smaller code blocks for data compression. The scan order of QTCs is related to the prediction direction during intra prediction. Therefore, the scan order may be in diagonal, vertical or horizontal direction. SBH processes coded video data based on 4×4 blocks after processing of transformation (T) and quantization (Q) and scans QTCs in diagonal direction. For the QTCs in an 8×8 transform block, the transform block 110 is divided into four 4×4 scan blocks such as scan block 120 when processing SBH. SBH scans QTCs of transform block 110 in diagonal direction both in each 4×4 scan block and between 4×4 scan blocks, as shown by the arrows in FIG. 1. FIG. 2 illustrates an example of QTCs in an 8×8 transform block 210. The 8×8 transform block is divided into four 4×4 scan blocks in which block 220 is the first sub block and block 230 is the last sub block when it is processed by SBH. The non-zero QTCs are shown by shaded cubes such as QTC 240, zero QTCs are represented by other blank cubes such as QTC 250, and DC represents the direct current (DC) position of block 230. When SBH processes QTCs of a scan block within a transform block, QTCs are arranged as one dimensional array in scan order, as shown in FIG. 3, in which QTC 310 is the DC position, QTC 320 is the first non-zero QTC and QTC 330 is the last QTC of the scan block. SBH process may also scan from the last non-zero QTC of the last sub block to the first QTC (DC position) of the first sub block of the transform block. When SBH process is enabled, a scan block is processed to identify whether it is the last sub block of a transform block, as shown in FIG. 4. If the scan block is the last sub block, then the process to select a value-modification QTC to be modified starts from the last non-zero QTC. Otherwise the process to select a value-modification QTC to be modified starts from the last QTC.

Although sign data hiding improves coding gain, it also comes with a cost of increased coding complexity and storage requirement.

For traditional video coding or HEVC without SBH, video data is processed in turn by transformation (T), quantization (Q), inverse quantization (IQ) and inverse transformation (IT) as shown in FIG. 5. The SBH process evaluates the quantized coefficients in a scan order and decides whether to “hide” the sign bit of the first non-zero quantized transform coefficient according to the evaluation result. The hiding of the sign bit of the first non-zero quantized transform coefficient is achieved by adjusting the value of a quantized transform coefficient selected from the first non-zero quantized transform coefficient to the last quantized transform coefficient in a scan order. The different processing orders and block sizes between transformation and SBH will increase coding complexity and storage requirement for storing data for SBH. For video compression, video data is transformed on multiple transform block sizes, such as 4×4, 8×8 16×16, 32×32. The processing of quantized transform QTCs in SBH is based on 4×4 blocks as shown in FIG. 6. The output from transformation is row-by-row or column-by-column and so is the output from quantization. Therefore, QTCs need to be stored for SBH since SBH processes the QTCs diagonally. This design imposes extra requirement for storing the QTCs arrays. And the cost of the storage increases as the transform block size increases, up to the size of a full transform block (TB). For example, the output of transformation in an 8×8 block is in the way of row-by-row as shown by the arrow in FIG. 7A or column-by-column as shown by the arrow in FIG. 7B. For processing, the QTCs of an 8×8 transform block can be divided into four coefficient groups (CGs), which are represented by number 0, 1, 2 and 3 respectively as shown in FIG. 8A to FIG. 8C. The CGs can be four 4×4 blocks arranged diagonally as shown in FIG. 8A, 2×8 blocks arranged horizontally as shown in FIG. 8B or 8×2 blocks arranged vertically as shown in FIG. 8C. In SBH, the processing of QTCs is based on a 4×4 CG. The scan orders in a 4×4 block and between 4×4 blocks of a transform block are both diagonal, as shown by the arrows in FIG. 1. FIG. 9A and 9B illustrate another example based on a 16×16 transform block. In this example, the output of the transform blocks is still in the way of row-by-row or column-by-column while QTCs of each transform block are divided into 16 CGs for SBH processing. The scan order of the 16 CGs numbered from 0 to 15 is diagonal as shown by the arrows in FIG. 9A and the scan order of the QTCs in each CG or between CGs is shown by the arrows in FIG. 9B. The QTCs may also be scanned according to the opposite direction of the arrows in FIG. 9B from CG 15 to CG 0. The QTC arrays are stored up to full QTCs of TB in order to divide the QTCs into CGs for scanning according to traditional HEVC with SBH. When large size of transform block, such as 16×16 or 32×32, is adopted, the cost for buffering transform or quantized transform coefficient arrays increases. Moreover, for compensation of SBH, the cost of sign bit hiding compensation in each QTC position and the distortion caused by quantization are computed. Therefore, the storage requirement also increases for buffering transform coefficient arrays and cost arrays of sign bit hiding.

As the process of SBH scans QTCs and computes the cost of modifying QTCs of a transform block sequentially, the critical path latency of video encoding is significantly increased and the overall throughput is limited.

In order to reduce the cost of computation and storage especially in the encoder engine and improve the encoder performance, it is desirable to develop new video coding or image processing method associated with SBH to reduce the storage requirement and increase the parallelism. This motivated the present invention.

### SUMMARY

Methods and apparatus of processing transform coefficients for a video encoder, a video decoder or an image processor are disclosed. Embodiments according to the present invention are used to reduce the storage requirement or increase the parallelism of coding. According to one embodiment of the present invention, the method of processing transform coefficients for a video encoder or an image processor comprises: receiving one or more quantized transform coefficients (QTCs) of a transform block from a media or a processor, wherein the transform block consists of M QTCs, M is a first positive integer, and the transform block is divided into one or more scan blocks; and applying sign bit hiding (SBH) process on N QTCs before the remaining QTCs of the transform block are received, wherein N is a second positive integer smaller than M. The SBH process comprises encoding a sign flag for each non-zero QTC of the scan block except for a candidate QTC. The SBH process may further comprise modifying the value-modification QTC by a modification value in a selected range of QTCs of the scan block depending on the result of parity checking. The modification value may be +1 or −1. The value-modification QTC may be identified according to the minimum cost function, wherein the cost function is related to quantization distortion due to value modification associated with a corresponding QTC. SBH may comprise checking the distance between the first non-zero QTC and the last non-zero QTC of a scan block to determine whether to enable SBH compensation by modifying a value-modification QTC. The selected range of QTCs may correspond to a first non-zero QTC of one scan block, a last non-zero QTC of one scan block, a last QTC of one scan block, the first non-zero QTC to the last non-zero QTC of one scan block, the first non-zero QTC to the last QTC of one scan block, the last non-zero QTC to the last QTC of one scan block, or consecutive 8 QTCs of one scan block, wherein the transform block is divided into one or more scan blocks. When computing the cost function, a first cost function for a first zero QTC and a second cost function for a non-zero QTC of one scan block are different, or a third cost function for a second zero QTC in a first region and a fourth cost function for a third zero QTC in a second region of one scan block are different. The SBH process may comprise computing cost functions of a first QTC and a second QTC of the scan block concurrently. The SBH process may also comprise computing cost functions of a first QTC and a second QTC concurrently, wherein the first QTC and the second QTC belong to two different scan blocks.

According to another embodiment of the present invention, the method of processing transform coefficients for a video encoder or an image processor comprises receiving quantized transform coefficients of a transform block from a media or a processor, wherein the transform block is divided into one or more scan blocks; encoding a sign flag for each non-zero quantized transform coefficient (QTC) of the scan block except for the candidate QTC; identifying a value-modification QTC in a selected range of QTCs of the scan block depending on the result of parity checking, wherein the value-modification QTC has the smallest cost function in the selected range of QTCs and the cost function is related to quantization distortion due to value modification associated with a corresponding QTC by a modification value, and wherein a first cost function associated with a first QTC in the scan block and a second cost function associated with a second QTC in the scan block are determined concurrently; and modifying the value-modification QTC by the modification value corresponding to the smallest cost function depending on the result of parity checking. The modification value may be +1 or −1. When computing cost, a third cost function associated with a third QTC in a first scan block and a fourth cost function associated with a fourth QTC in a second scan block are determined concurrently. All zero QTCs in the scan block may use a same cost function.

According to one embodiment of the present invention, the method of processing transform coefficients for a video encoder or decoder comprises: receiving video data associated with quantized transform coefficients (QTCs) of a transform block from a media or a processor, wherein the transform block is divided into one or more scan blocks; applying parity checking on QTCs of the scan block based on the least significant bits (LSBs) of the QTCs; and applying sign bit hiding (SBH) compensation process to a value-modification QTC in a selected range according to a result of the parity checking. The parity checking may correspond to exclusive OR (XOR) operations on the LSBs of all QTCs of the scan block or all non-zero QTCs of the scan block. The parity checking may correspond to summation operations on the LSBs of all QTCs of the scan block or all non-zero QTCs of the scan block and a modulo 2 operation on result of the summation operations. The SBH compensation process in the video decoder corresponds to changing the candidate QTC to a negative value if the result of the parity checking indicates the sign bit of the candidate QTC is hidden, and in the video encoder SBH compensation process corresponds to modifying a value-modification QTC by a modification value corresponding to +1 or −1.

An apparatus of processing transform coefficients for a video encoder or decoder is also disclosed in the present invention. According to one embodiment of the present invention, the apparatus comprises means for receiving one or more quantized transform coefficients (QTCs) of a transform block from a media or a processor, wherein the transform block consists of M QTCs, M is a first positive integer, and the transform block is divided into one or more scan blocks; and means for applying sign bit hiding (SBH) process on N QTCs before remaining QTCs of the transform block are received, wherein N is a second positive integer smaller than M. The SBH process comprises means for encoding a sign flag for each non-zero QTC of the scan block except for the candidate QTC and means for modifying a value-modification QTC in a selected range of QTCs of the scan block depending on a result of parity checking, wherein the value-modification QTC is modified by a modification value if said modifying the value-modification QTC is performed.

According to one embodiment of the present invention, an apparatus of processing transform coefficients for a video encoder or an image processor comprises means for receiving quantized transform coefficients of a transform block from a media or a processor, wherein the transform block is divided into one or more scan blocks; means for encoding a sign flag for each non-zero quantized transform coefficient (QTC) of the scan block except for the candidate QTC; means for identifying a value-modification QTC in a selected range of QTCs of the scan block depending on a result of parity checking, wherein the value-modification QTC has smallest cost function in the selected range of QTCs and the cost function is related to quantization distortion due to value modification associated with a corresponding QTC by a modification value, and wherein a first cost function associated with a first QTC in the scan block and a second cost function associated with a second QTC in the scan block are determined concurrently; and means for modifying the value-modification QTC by the modification value corresponding to the smallest cost function depending on the result of parity checking.

According to one embodiment of the present invention, an apparatus of processing transform coefficients for a video encoder or decoder, comprises means for receiving video data associated with quantized transform coefficients (QTCs) of a transform block from a media or a processor, wherein the transform block is divided into one or more scan blocks; means for applying parity checking on the scan block based on least significant bits (LSBs) of the QTCs; and means for applying sign bit hiding compensation process to a value-modification QTC according to a result of the parity checking.

### BRIEF DESCRIPTION OF THE DRAWINGS

FIG. 1 illustrates an exemplary scan order of quantized transform coefficients for SBH (sign bit hiding) based on an 8×8 transform block.

FIG. 2 illustrates an exemplary 8×8 transform block to be processed by SBH.

FIG. 3 illustrates an exemplary quantized transform coefficients arrangement wherein quantized transform coefficients (QTCs) are aligned into one dimensional array according to the scan order.

FIG. 4 illustrates an exemplary flow chart of determining the starting point of determining the value-modification QTC to be modified for SBH compensation.

FIG. 5 illustrates an exemplary flow from transformation (T) to inverse transformation (IT) in traditional video coding or HEVC without SBH.

FIG. 6 illustrates an exemplary flow from transformation (T) to inverse transformation (IT) in HEVC with SBH.

FIG. 7A illustrates an exemplary row-by-row output of transform coefficients based on an 8×8 transform block.

FIG. 7B illustrates an exemplary column-by-column output of transform coefficients based on an 8×8 transform block.

FIG. 8A illustrates an exemplary horizontal arrangement of four coeffficient groups.

FIG. 8B. illustrates an exemplary vertical arrangement of four coefficient groups.

FIG. 8C illustrates an exemplary diagonal arrangement of four coefficient goups.

FIG. 9A illustrates an exemplary scan order of 16 coefficient groups in a 16×16 transform block.

FIG. 9B illustrates an exemplary scan order of each coefficient in a 16×16 transform block as illustrated in FIG. 9A.

FIG. 10A illustrates a coding segment of an exemplary syntax design used for SBH in HEVC.

FIG. 10B illustrates an exemplary syntax design of SBH in HEVC.

FIG. 10C illustrates a coding segment of an exempalry syntax design used for SBH in HEVC.

FIG. 11 illustrates an exemplary flow chart to identify the value-modification transform coefficient to be modified for SBH compensation.

FIG. 12 illustrates an exemplary coding segment used for sign bit hiding evaluation.

FIG. 13A illustrates an exemplary coding segment used for computing quantized distortion of each transform coefficient.

FIG. 13B illustrates an exemplary coding segment used for adopting a cost function according to zero or non-zero QTC and comparing the corresponding cost.

FIG. 14 illustrates an exemplary coding segment of SBH process.

FIG. 15 illustrates an exemplary one demensional QTC array of a scan block.

FIG. 16 illustrates example of different SBH compensation methods based on different ranges of QTCs.

FIG. 17A illustrates an exemplary output of an 8×8 transform block.

FIG. 17B illustrates an example of SBH process based on an 8×8 transform block according to the present invention.

FIG. 18A illustrates an exemplary output of a 16×16 transform block.

FIG. 18B illustrates an example of SBH process based on a 16×16 transform block according to the present invention.

FIG. 19A illustrates an exemplary flowchart for video coding method with SBH according to the present invention.

FIG. 19B illustrates an exemplary 16×4 CG (coefficient group) divided into four scan blocks during a 4×4 block processing.

FIG. 20 illustrates an exemplary flowchart of processing QTCs for a video encoder according to one embodiment of the present invention.

FIG. 21 illustrates an exemplary flowchart of processing QTCs for a video encoder according to another embodiment of the present invention.

FIG. 22 illustrates an exemplary flowchart of processing QTCs for a video encoder or decoder according to another embodiment of the present invention.

### DETAILED DESCRIPTION

In order to improve the performance, embodiments according to the present invention refine traditional HEVC with SBH process to enable parallel processing of SBH. Embodiments according to the present invention also refine traditional HEVC with SBH process to reduce the storage requirement. Moreover, the SBH process according the present invention can also be used for image or picture processing.

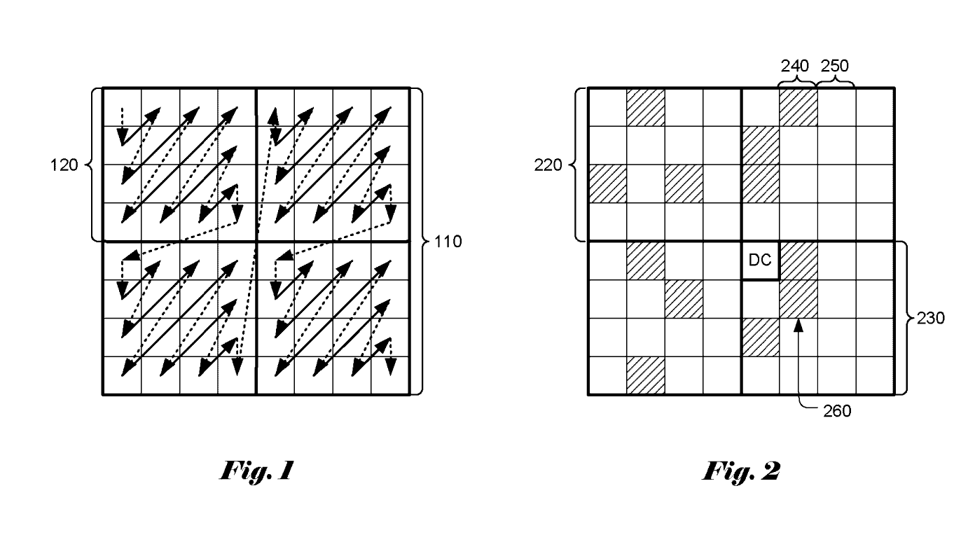

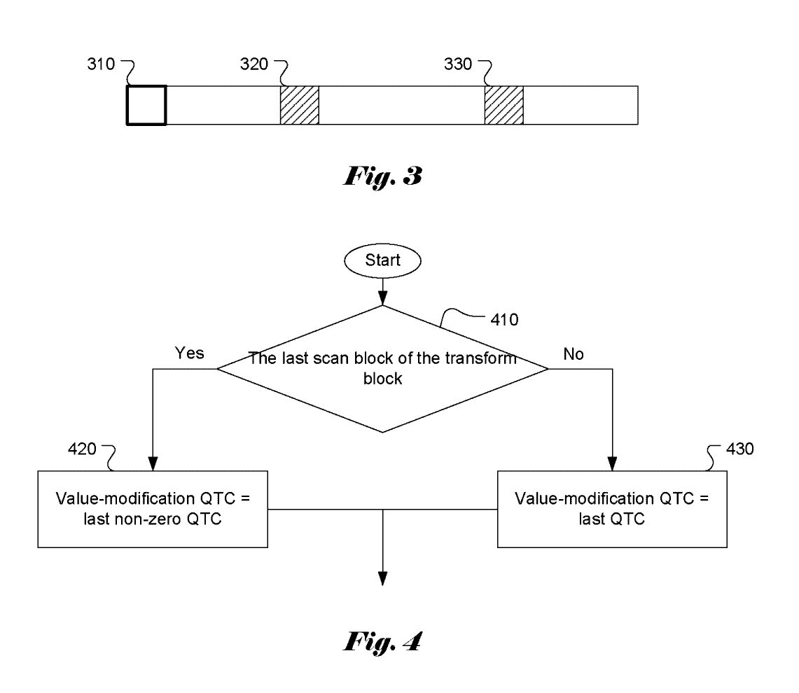

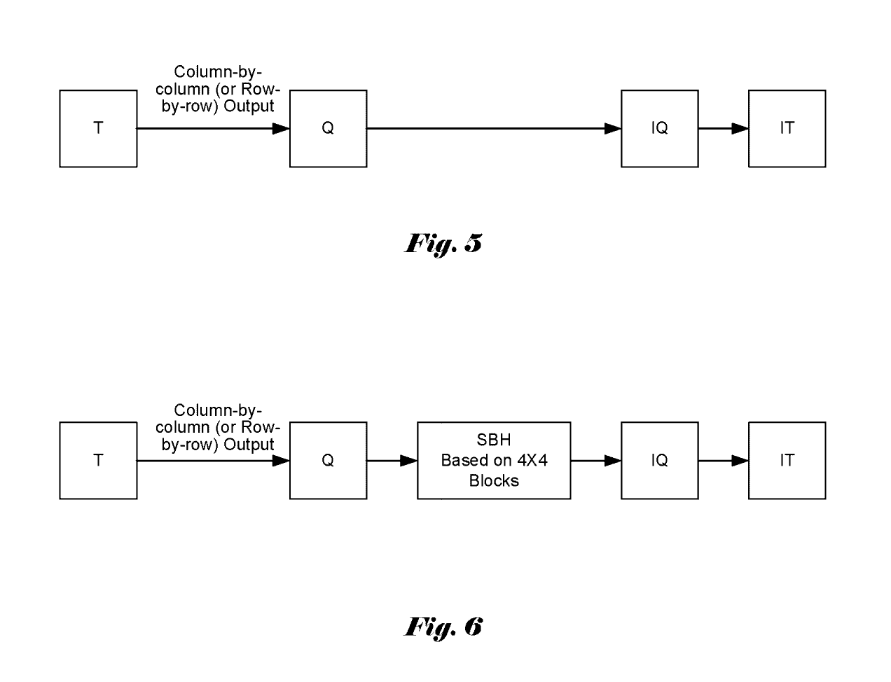

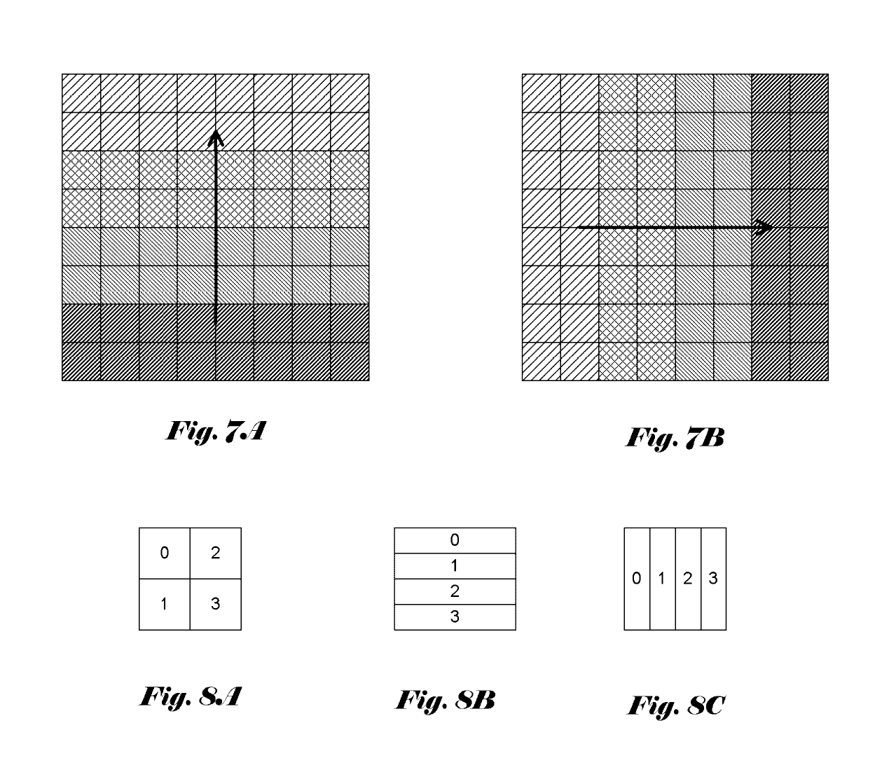

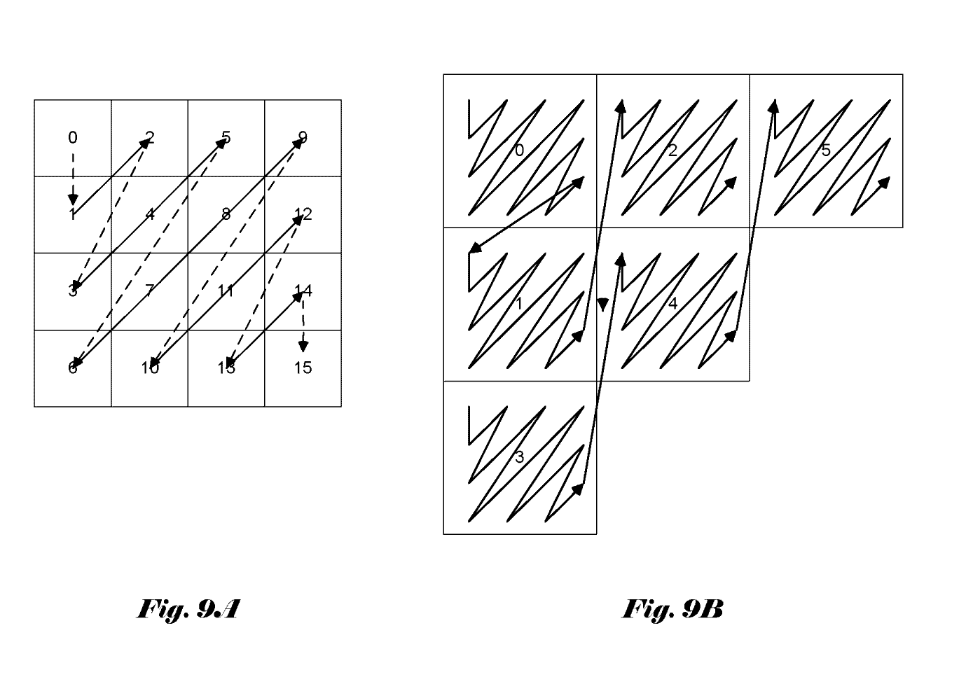

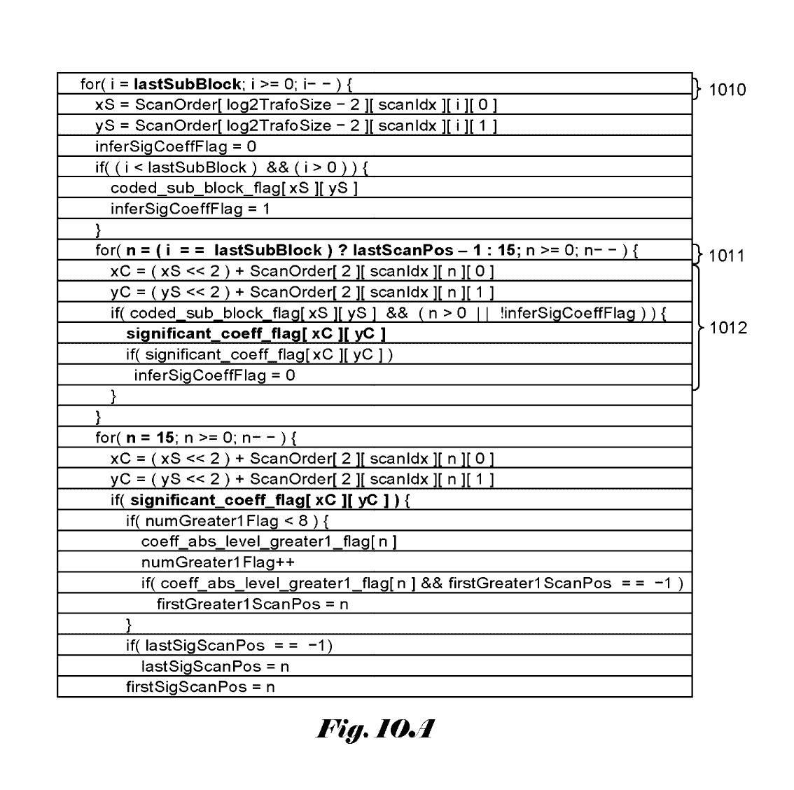

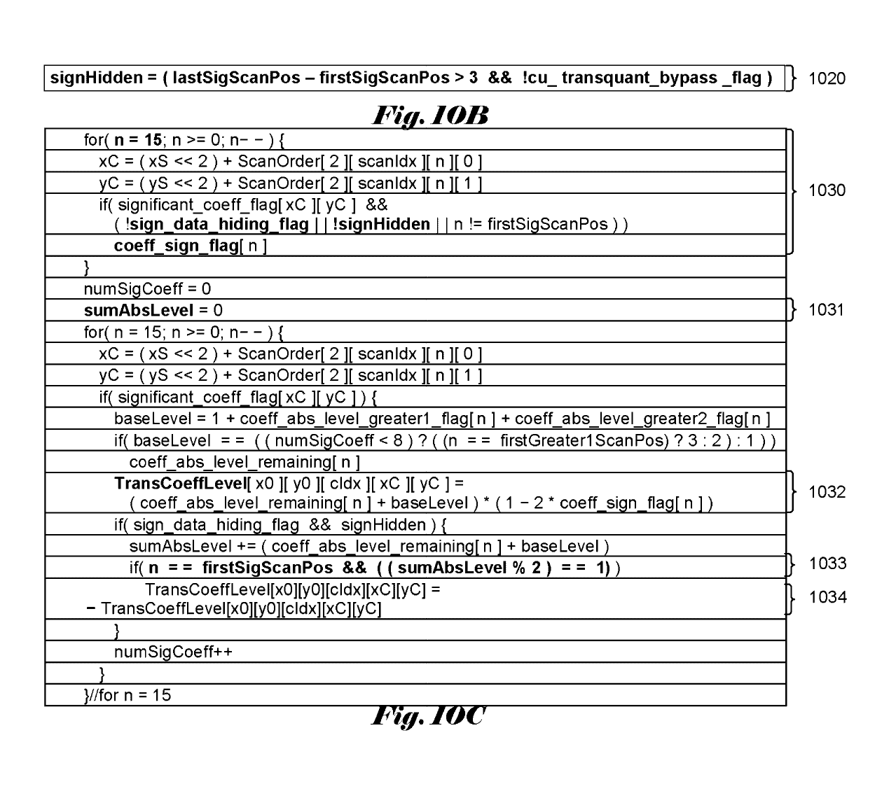

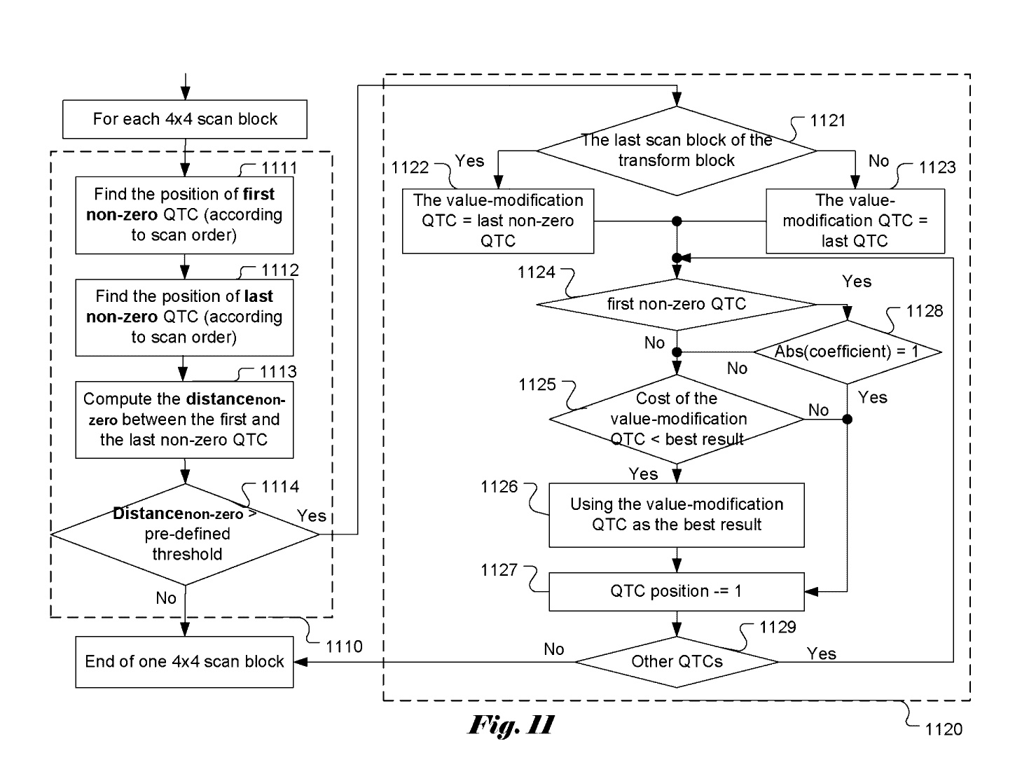

FIG. 10A, FIG. 10B and FIG. 10C illustrate an exemplary syntax design of traditional SBH used in HEVC draft specification (JCTVC_J1003_d7.doc). The parameter significant_coeff_flag[xC][yC] is used to code the significant bit of the QTC to be processed. Coding segment in block 1012 is used to decode significant_coeff_flag[xC] [yC]. Parameter lastScanPos in block 1011 indicates the last scan position and n is in a range from 0 to either 15 or lastScanPos. The parameter lastSubBlock in blocks 1010 and 1011 indicates the last sub block of a transform block to be scanned. When the QTC to be processed is not equal to zero, and when the current QTC is not the first QTC in a scan block or a given flag inferSigCoffFlag is unset, “significant_coeff_flag[xC] [yC]” is 1, otherwise it is 0. To use SBH in an 8×8 transform block, the transform block is divided into four 4×4 scan blocks. Each scan block contains 16 QTC positions. As shown in FIG. 2, when the scan block is the last scan block (lastSubBlock) 230, the last scan position (lastScanPos) is the last non-zero QTC 260, otherwise the last scan position is the last QTC of a scan block. The syntax design in block 1020, as shown in FIG. 10B, is used to determine whether to enable sign bit hiding. The SBH process is enabled when the distance between the first non-zero QTC (or the first significant scan position firstSigScanPos) and the last non-zero QTC (or the last significant scan position lastSigScanPos) is larger than a threshold of 3. For each 4x4 scan block, a control flag coeff sign flag [n] is coded for each non-zero QTC in block 1030. The variable parameter sumAbsLevel as shown in block 1031 indicates the sum of absolute value to be used for Parity Checking. The variable parameter TransCoeffLevel represents the value of a non-zero QTC in block 1032. The parameter sumAbsLevel % 2 in block 1033 determines the parity checking result. The negative sign “−”in block 1034 is used to recover the hidden sign of the first non-zero QTC when the conditions in block 1033 are fulfilled.

FIG. 11 illustrates an exemplary encoding flow chart to identify the value-modification QTC to be modified for SBH compensation. Besides hiding the sign bit of the candidate QTC, the SBH process further includes SBH evaluation 1110 and a process 1120 for identifying a value-modification QTC according to the minimum cost function. The SBH process is applied to each scan block of size 4×4 regardless of which transform size was applied. For each 4×4 scan block, the SBH evaluation 1110 involves four steps to determine whether to enable of SBH process. QTCs are processed to find the position of the first non-zero QTC according to the scan order in step 1111, and then are processed to find the position of the last non-zero QTC according to the scan order in step 1112. The distance between the first and the last non-zero QTC is computed as distance_{non-zero} in step 1113. By comparing distance_{non-zero} to a pre-defined threshold in step 1114, it can be determined whether the first non-zero sign bit in this block can be skipped in the encoder if the distance_{non-zero} is larger. Otherwise, when distance_{non-zero} is not larger than the pre-defined threshold, SBH evaluation is ended in the current 4×4 scan block. In sign bit hiding process 1120, when distance_{non-zero} is larger than the pre-defined threshold, the current 4×4 scan block is processed to determine whether the 4×4 scan block is the last scan block of the transform block in step 1121. Step 1121 is used to decide the starting point of determining the value-modification QTC to be modified for each scan block. If the 4×4 scan block is the last scan block of the transform block, the determination of the value-modification QTC to be modified starts from the last non-zero QTC. If it is not the last scan block, the determining of the value-modification QTC to be modified starts from the last QTC of the 4×4 scan block. QTCs are processed to determine whether the value-modification QTC is the first non-zero QTC of the 4x4 block in step 1124. If the value-modification QTC is not the first non-zero QTC, the cost of the value-modification QTC is compared to the best result which is the current minimum cost stored in step 1125. When the cost of the value-modification QTC is less than the best result, the value-modification QTC is used as the best result of SBH compensation in step 1126, the best cost in 1125 is updated and the value-modification QTC to be processed moves to the next position in step 1127 (by coefficient position−=1). Otherwise, if the cost of the value-modification QTC is not less than the best cost, the value-modification QTC to be processed moves to the next position directly. When the value-modification QTC is the first non-zero QTC, it is then checked whether the absolute value (Abs) equals to 1 or not in step 1128. If the Abs of the first non-zero QTC is not 1, the cost of the first non-zero QTC is compared with the best cost in step 1125 to decide whether to use the first non-zero QTC as the best result. If the Abs of the first non-zero QTC is 1, the position to be processed moves directly to the next position in step 1127 skipping the comparison to the best cost. Step 1129 is used to determine whether there are other QTCs at next position. If it indicates the next position contains other QTCs, the next QTC as the next value-modification QTC in the next position is processed from step 1124 again. If the result of the step 1129 indicates there is no other QTC, the sign bit hiding process is finished in this 4×4 scan block.

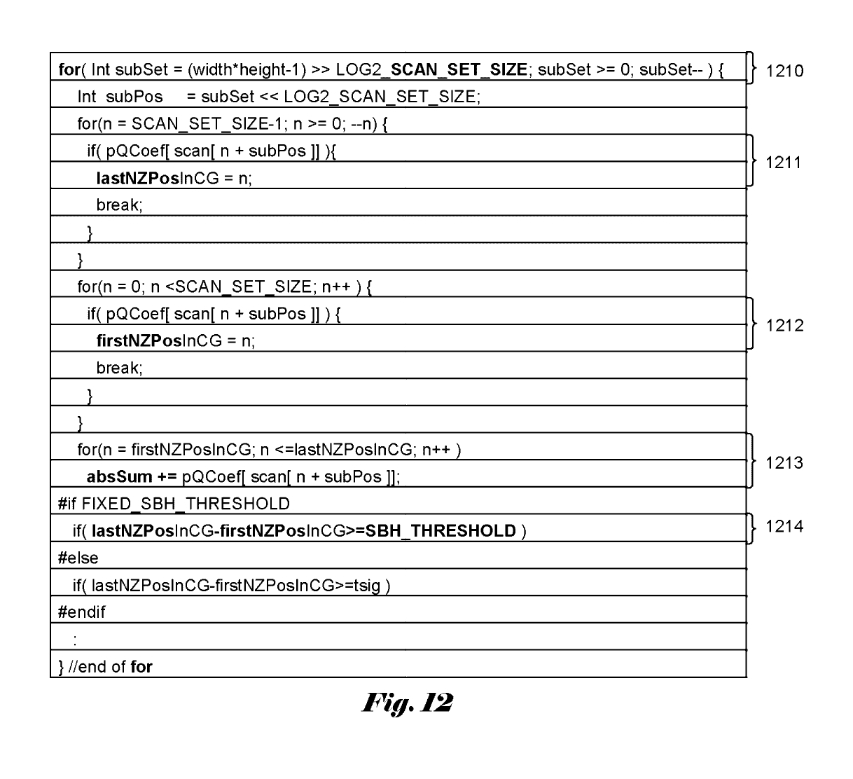

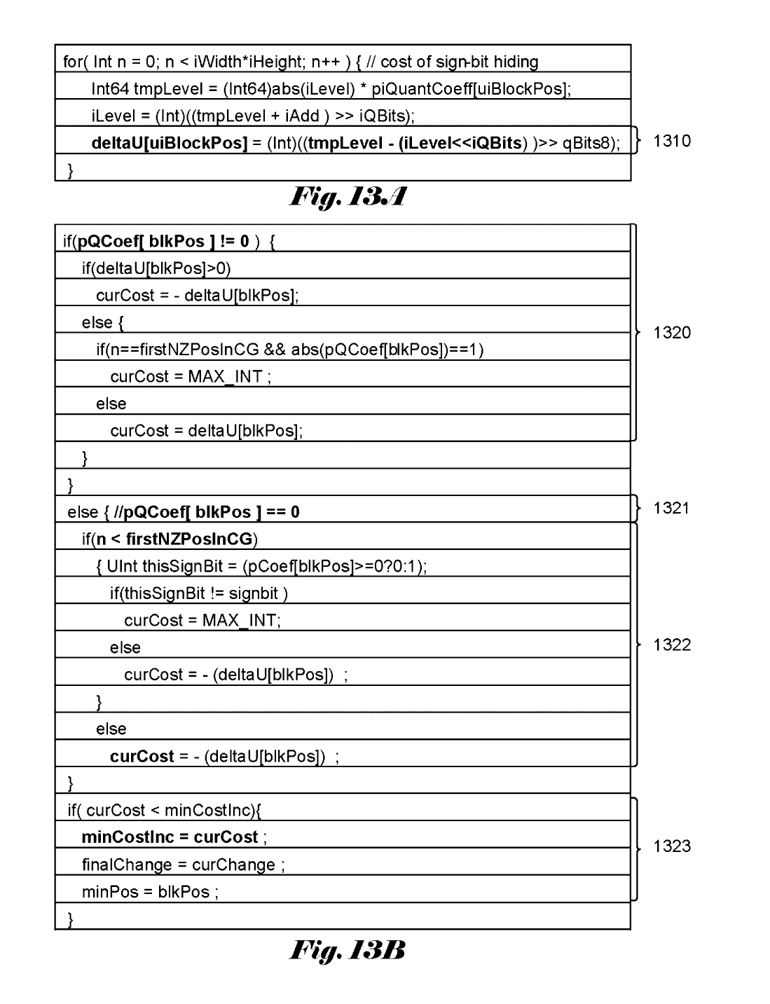

An exemplary code segment of official HEVC encoder program for sign bit hiding evaluation of each 4×4 scan block is shown in FIG. 12. Code block 1211 is used to find the position of the last non-zero QTC and code block 1212 is used to find the position of the first non-zero QTC. Two conditions are used to determine whether to enable the compensation for SBH. The first condition is whether the distance between the last non-zero position and the last non-zero position is larger than or equal to a threshold which is computed by the code “lastNZpos−firstNZpo>=threshold” in block 1214. In block 1214, the last and the first non-zero position are indicated by variables “lastNZpos” and “firstNZpos” respectively. The second condition for determining the compensation for SBH is related to the absolute value sum (which is represented by absSum in block 1213) of parity checking from the first non-zero to the last non-zero QTCs which is determined in block 1213. When the distance reaches the SBH threshold and absSum is an odd number, the two conditions of compensation are met and the compensation for SBH is enabled.

In the SBH process, quantization distortion of each QTC is computed and stored for SBH compensation. FIG. 13A illustrates an exemplary code segment for computing quantization distortion of each QTC in which parameter deltaU[uiBlockPos] in block 1310 represents quantization distortion for a QTC at a position represented by variable uiBlockPos. FIG. 13B illustrates an exemplary code segment for computing the cost of sign bit hiding compensation in a different QTC position and searching for the best cost position associated with the minimum cost function. In the code segment shown in FIG. 13B, computation of pQCoef [blkpos] !=0 in block 1320 and pQCoef [blkpos]==0 in block 1321 are used to identify whether each QTC is non-zero or zero and then to decide whether to adopt different cost function related to quantization distortion. All the QTCs in a 4×4 scan block are located in two regions. The first region is the zero-value region located before the first non-zero QTC in the one dimensional array of QTCs and the second region is the region from the first non-zero QTC to the last QTC of the 4×4 scan block, not including the last non-zero QTC itself. Computing result of the “n<fistNZPosInCG” is used to identify whether the zero-value QTC is in the first region or in the second region. Based on the region information of a QTC, the cost function of the current zero QTC represented by curCost is determined in block 1322. After determination of the cost function to be used, the code segment in block 1323 is used to select the QTC to be modified for compensation. The parameter “minPos” is used to indicate the position of the QTC with minimum cost “minCostInc”, and the selected QTC will be modified with a modification value such as +1 or −1.

In order to improve the parallelism and reduce storage requirement, embodiments of the present invention disclose method and apparatus of processing transform coefficients in video encoder or decoder associated with SBH. According to one embodiment of the present invention, QTCs of partial transform block are processed by SBH before all the QTCs of a transform block are received. As the SBH process scans QTCs without the availability of the whole transform block, the encoding algorithm used in HEVC test model (HM) reference program needs to be refined. According to another embodiment of the present invention, the QTCs are processed in parallel. For example, zero and non-zero QTCs can be processed to compute cost functions concurrently. Multiple scan blocks maybe processed to compute cost functions concurrently and partial QTCs of each scan block may also be processed concurrently before all the QTCs of multiple scan blocks are received. According to embodiments of the present invention, several selected ranges of value-modification QTCs which are less than the whole scan block can be used. According to one embodiment of the present invention, by simplifying parity generation and parity checking, critical path of multiple coefficients can be reduced.

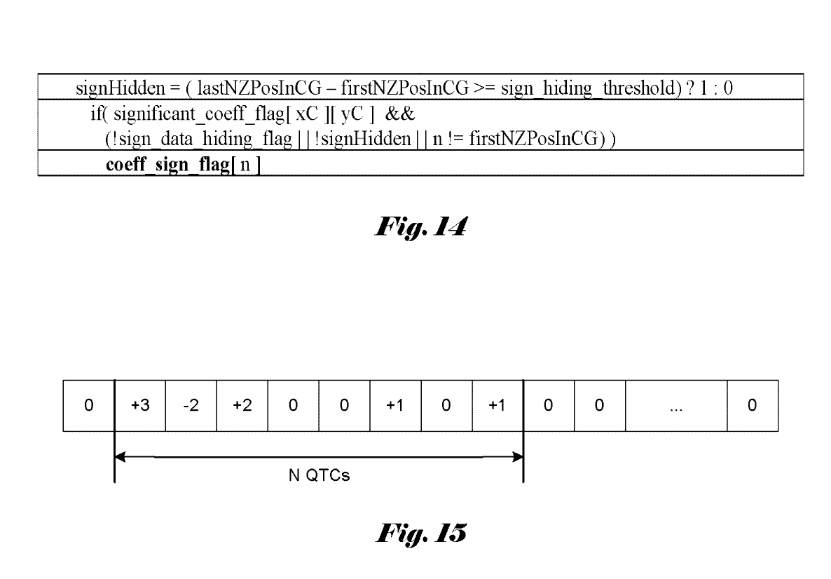

According to the present invention, when the number of QTCs from the first non-zero QTC to the last non-zero QTC of a scan block is equal to or larger than a given sign bit hiding threshold (TSIG), SBH process is enabled to hide the sign bit of the candidate QTC. The candidate QTC may be the first non-zero QTC of the scan block. In other word, the first sign bit of the candidate QTC does not need to be encoded. FIG. 14 illustrates one exemplary syntax design for comparing the distance with TSIG. A control flag coeff_sign_flag [n] is encoded for each non-zero QTC except for the candidate QTC wherein the sign bit of the candidate QTC is inferred from parity checking associated with other QTCs. In order to match the parity bit of the sum of the QTC levels so that the first sign bit of the non-zero QTC can be inferred correctly at the decoder side, one QTC level is adjusted in the sign bit hiding process. For example as shown in FIG. 15, the QTC array of a quantized residual block has N QTCs from the first non-zero to the last non-zero QTCs, in which the first non-zero QTC is +3 and the last non-zero QTC is +1. In this example, the N QTCs are also used as the selected range of QTCs for searching for a value-modification QTC with the minimum cost function for SBH compensation. If TSIG is 3 and the distance between the first and the last non-zero QTC is eight which is larger than the preset TSIG, the SBH process is enabled and the sign bit of the candidate QTC is hidden. If the first non-zero QTC is the candidate QTC, sign bit hiding process hides the first sign bit “+”of the first non-zero QTC “+3”. As the sign of the first non-zero QTC is +, the sum of absolute value of all non-zero QTCs of the scan block should be an even value. However, the absolute values sum is 9 which does not match with the sign bit of the candidate QTC in this example. Therefore, the SBH compensation is enabled. A value-modification QTC with the lowest cost of compensation is modified by a modification value in SBH process for parity checking. In this example, if the best result for compensation is “+2”, QTC “+2” is modified with a modification value. If the modification value corresponds to “+1” or “−1”, QTC “+2” is modified to “+3” or “+1” depending on which one has the lower cost for SBH compensation. If the modification value corresponds to “+3” or “−3”, QTC “+2” is modified to “+5” or “−1” depending on which one has the lower cost for SBH compensation.

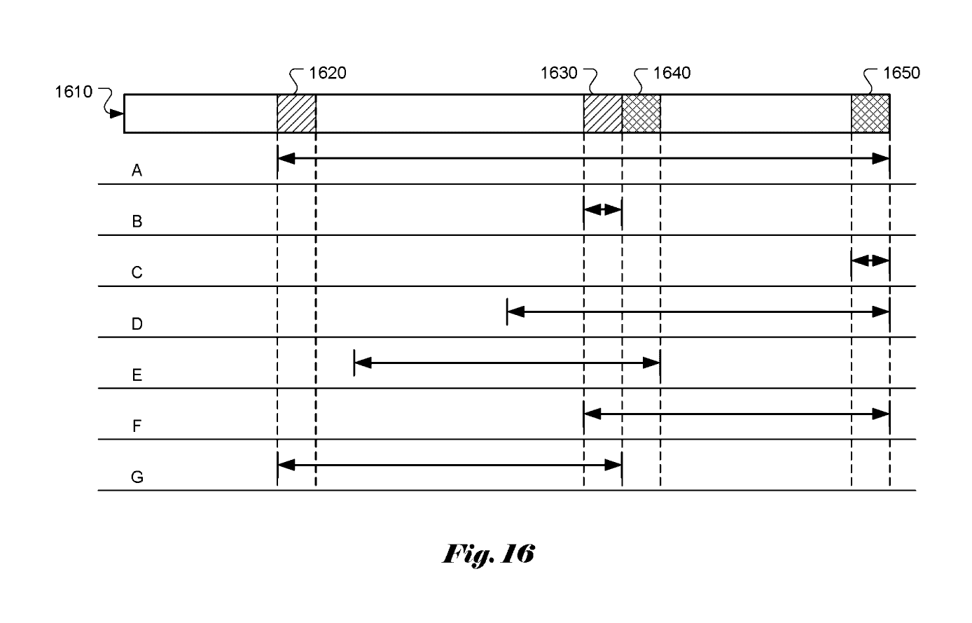

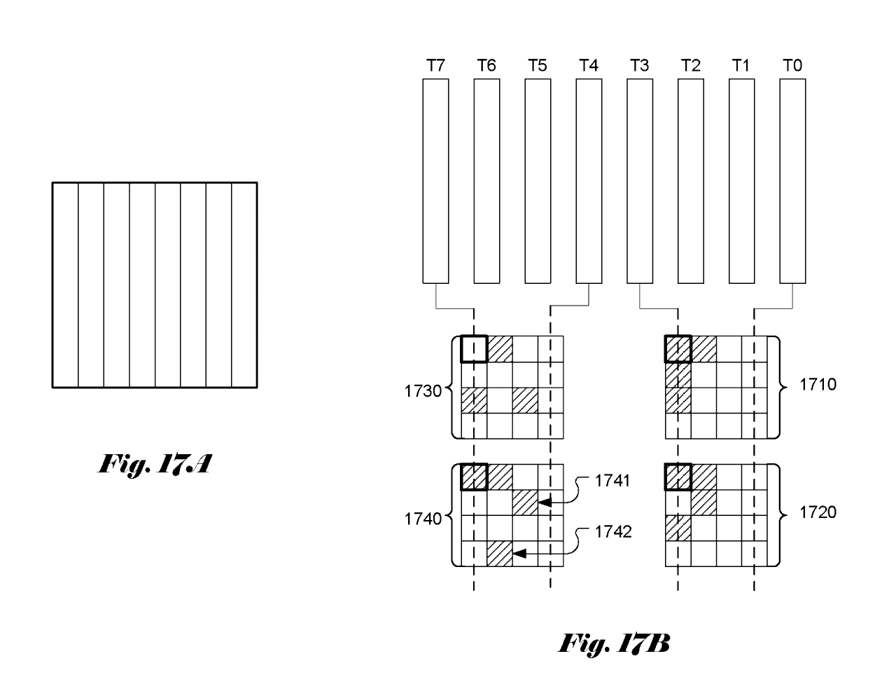

According to the present invention, the range of candidate value-modification QTCs for searching for a value-modification QTC with the minimum cost function to perform SBH compensation is also modified. Therefore, costs of candidate value-modification QTCs are computed and compared in a smaller range than the whole scan block and the value-modification QTC with minimum cost would be modified so that the parity bit of the absolute value sum of all QTCs or all non-zero QTCs of the scan block match with the sign bit of the candidate QTC to be hidden in the encoding side and to be inferred in the decoding side. Instead of using all the QTCs in a scan block, methods based on different smaller selected ranges of QTCs are used according to the present invention. FIG. 16 illustrates examples of compensation method based on different selected range. For a QTC line 1610 in scan order, method A is based on the range from the first non-zero QTC 1620 to the last QTC 1650. Methods B and C are based on only one QTC, which corresponds to the last non-zero QTC 1630 and the last QTC 1650 respectively. Methods D and E are based on fixed size range such as a preset range with 8 consecutive QTCs. The range ends in the position of the last QTC 1630 in method D and it ends in the position of QTC 1640 just after the last non-zero QTC in method E. Method F is based on the range from the last non-zero to the last QTCs and method G is based on the range from the first non-zero to the last non-zero QTCs. In each of these selected ranges, cost functions of each QTC are computed and compared. A value-modification QTC with the minimum cost function can be modified so that the parity bit of the sum of QTC levels (or amplitudes) matches the sign bit that is hidden.

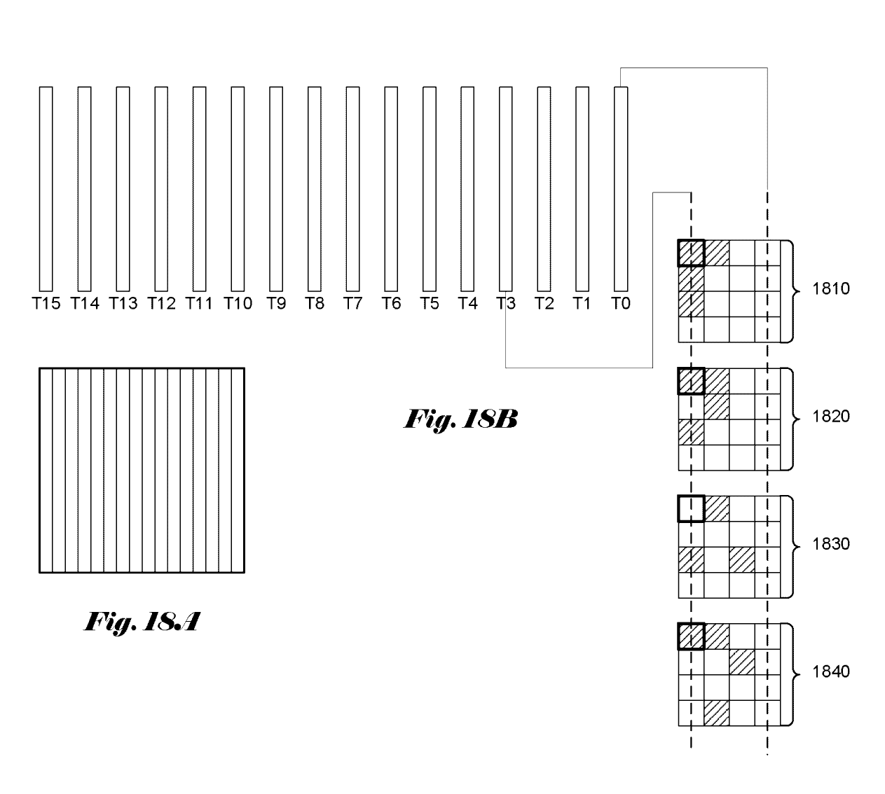

FIG. 17A and FIG. 17B illustrate an example according to embodiments of the present invention, in which SBH is applied to multiple scan blocks of an 8×8 transform block concurrently. The transform block consists of video data or image data. In this example, the output of this transform block takes 8 cycles as shown in FIG. 17A. The 8 cycles in turn are denoted as cycle T0, T1, T2, T3, T4, T5, T6 and T7 as shown in FIG. 17B, wherein zero QTCs are represented by blank cubes, non-zero QTCs are represented by shaded cubes and each direct current position of each scan block is represented by a DC. According to one embodiment of the present invention, zero and non-zero QTCs can be processed to compute cost functions concurrently, as shown by QTCs passed through by each dashed line. For example, after the fourth cycle T3, QTCs of two 4x4 scan blocks become available and are processed first without waiting for the availability of the rest of the scan blocks. According to another embodiment of the present invention wherein QTCs are processed in parallel, zero or non-zero QTCs in each cycle can be processed to compute cost functions concurrently, and multiple scan blocks can be processed concurrently. For example, zero or non-zero QTCs in cycle T0 are processed at the same time and scan blocks 1710 and 1720 are processed concurrently without waiting for all QTCs of the two scan block 1710 and 1720 to be received. QTCs of scan blocks 1730 and 1740 are also processed concurrently. Non-zero QTC 1742 is the last non-zero QTC of original scan block 1740. For cost functions computation, non-zero QTC 1741 is the first non-zero QTC to be processed by hardware or software.

FIG. 18A and FIG. 18B illustrate another example according to the present invention based on a 16×16 transform block of video data or image data. Similar to the example shown in FIG. 17A and FIG. 17B, the output of the 16×16 transform block takes 16 cycles as shown in FIG. 18A. The 16 cycles in turn are denoted as cycle T0 to T15 as shown in FIG. 18B, wherein zero QTCs are represented by blank cubes, non-zero QTCs are represented by shaded cubes and each direct current position of each scan block is represented by a DC. According to the present invention, zero and non-zero QTCs in the same cycle can be processed concurrently when QTCs of one cycle arrives. QTCs of four 4×4 scan blocks 1810 to 1840 formed by T0 to T3 can be processed first without waiting for the availability of the rest of the scan blocks of the transform block. Zero or non-zero QTCs in each cycle can be processed concurrently, and QTCs of the four scan blocks 1810 to 1840 can be processed concurrently.

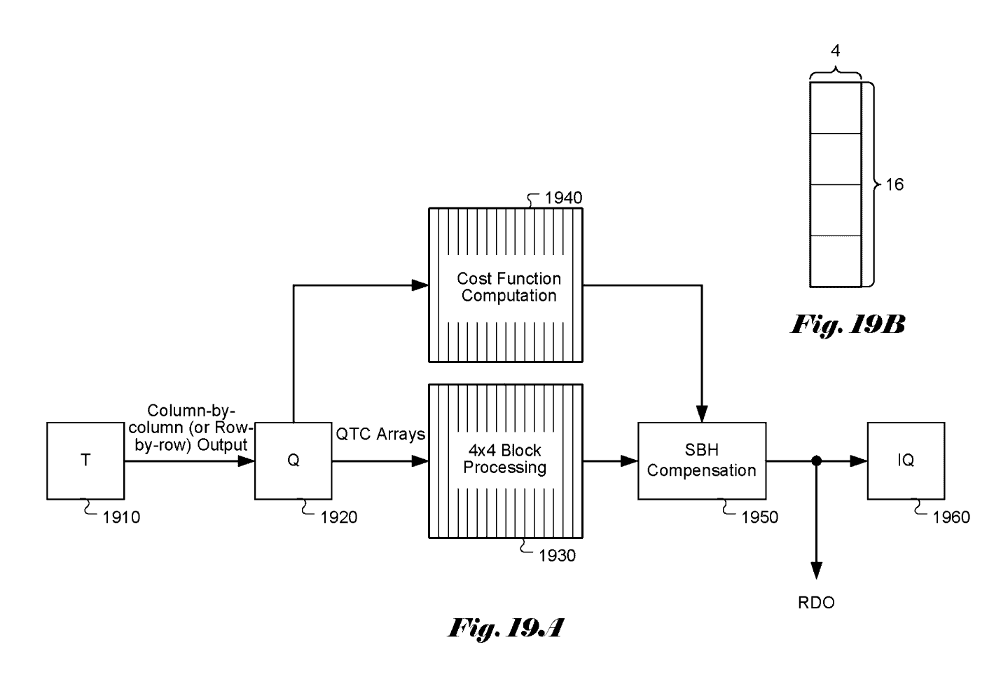

FIG. 19A illustrates an exemplary flow of video coding with SBH according to the present invention. Transformation 1910 processes video data and outputs transform coefficients row-by-row or column-by-column. Then transform coefficients or transform coefficient arrays are processed by quantization (Q) 1920. QTC arrays are divided into 4×4 scan blocks and are then processed by 4×4 block processing 1930 to determine whether to enable SBH and SBH compensation for each scan block. When a 16×16 transform block is processed and QTC arrays are provided in 16 cycles, the QTCs in each 16×4 coefficient group is divided into four scan block, as shown in FIG. 19B. The distortion of quantization is calculated and the cost function of SBH compensation related to quantization distortion is computed on each QTC position by cost function computation 1940. The cost function arrays and the result of the 4×4 block processing are supplied to SBH compensation 1950. When SBH compensation is enabled depending on the result of parity checking, cost functions for SBH compensation are compared and a value-modification QTC with the minimum cost function in a selected range is modified. According to one embodiment of the present invention, four times parallelism of SBH can be achieved for supporting 4×4, 2×8, or 8×2 coefficient groups in comparison with the traditional SBH process. The process in FIG. 19A can also be used for image or picture processing wherein the data processed by transformation 1910 comes from an image or a picture.

For each scan block, methods for searching for the minimum or the smallest cost function of SBH compensation are also disclosed in the present invention. According to one embodiment, QTC checking starts when the QTCs of the whole scan block are received in order to search for the smallest cost function. Each QTC is determined whether it is zero or non-zero first. Based on the result, the cost function is selected depending on whether the QTC is zero or non-zero. For zero QTCs, a cost function is selected from different functions based on whether the QTC is in the first region (before the first non-zero QTC) or the second region (from the first non-zero QTC to the last QTC). After the calculation of the cost function of SBH compensation related to quantization distortion, the search for the smallest cost function of SBH compensation is implemented using a parallel structure. According to one embodiment, the search for the smallest cost function of a value-modification QTC is based on parallel searches on all QTCs from a scan block. The cost function of SBH compensation on each QTC position is compared two-by-two at the same time. Then, the lesser cost function of SBH compensation in each comparing group is also compared in parallel style. This parallel comparison stops when the minimum cost of the scan block is found. According to another embodiment, one column or row of QTCs of a scan block are processed concurrently before the availability of all QTCs of the scan block. Each QTC of the column or row is determined whether it is zero or non-zero first and then the corresponding cost function would be used based on the result. For zero QTCs, each zero QTC is further examined to see whether it is in the first region or the second region and finally whether it is to be computed by different or the same cost function(s). After the cost functions of SBH compensation in each QTC position are computed, the cost functions of one row or one column of a scan block are compared two by two to find the minimum cost functions of each pair concurrently. Then the minimum cost functions of each pair are also compared two by two in parallel until the minimum cost function in the scan column or scan row is determined. The minimum cost function of the first row or column is stored in a register. The minimum cost function of the other row or column is compared to the saved minimum cost function in the register and the lesser cost function is used to update the register value as the saved minimum cost function. After all columns or rows are processed, the register will contain the minimum cost function of the scan block. In this embodiment, the non-zero QTC information such as the map of the non-zero QTC information of the scan block is stored for SBH.

In the present invention, a parity checking method for video coding with SBH is also disclosed. According to one embodiment of the present invention, the parity checking is applied to the Least significant bits (LSBs) of QTCs of a scan block to determine whether to perform SBH compensation operation or not. Instead of computing summation of all absolute values of QTCs of a scan block, the sum of the absolute values used for parity checking is computed by:

sumAbsLevel=Σ[coeff_value]

parity=sumAbsLevel % 2.

Only the least significant bits (LSBs) of absolute values of QTCs in a scan block are computed to determine whether to perform SBH compensation or not. The parity checking is generated by:

Parity=abs_coef_value[0]_bit_0 XOR abs_coef_value[1]_bit_0 XOR . . . abs_coef_value[15]_bit_0

where abs_coef_value[0]_bit_0 is bit 0 of the absolute value of the QTC in scan position 0, abs_coef_value[1]_bit_0 is bit 0 of the absolute value of the QTC in scan position 1, etc. To further simplify the computation, only non-zero valued QTCs are used to compute parity according to one embodiment of the present invention. Therefore only the LSB of all non-zero QTCs of a scan block is used to compute the sum of absolute values for parity checking. The SBH compensation operation may further comprises identifying the sign of the candidate QTC as negative when the parity check indicates so in decoder side. The candidate QTC is the first non-zero QTC of a scan block when performing picture decoding. The SBH compensation operation may further comprise modifying a selected value-modification QTC with +1 or −1 when performing picture encoding. The selected value-modification QTC has the smallest cost function for SBH compensation within a selected range of QTCs in a scan block.

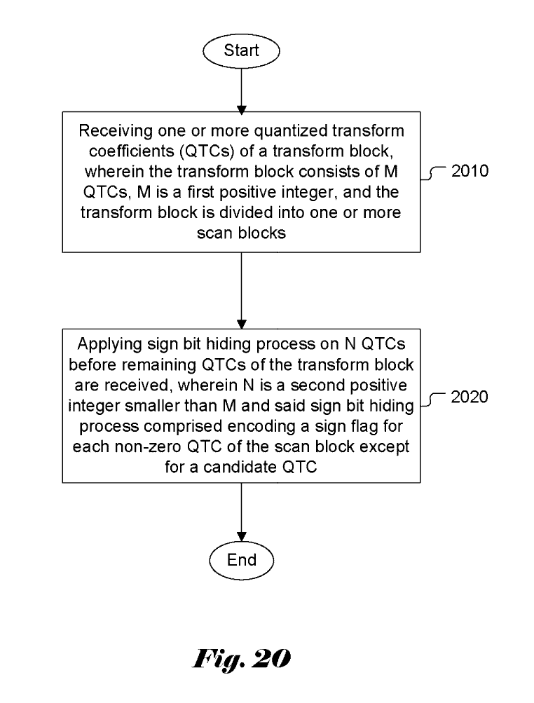

FIG. 20 illustrates an exemplary flowchart of processing transform coefficients with SBH process for a video coder incorporating an embodiment of the present invention. According to one embodiment, one or more quantized transform coefficients (QTCs) of a transform block are received as shown in step 2010. The QTCs may be from a media or a processor. The transform block consisting of M (representing the number of QTCs of the transform block) QTCs is divided into one or more scan blocks. The QTCs may be stored in a media of the system for the next processing. In order to reduce the storage requirement, sign bit hiding process is applied on N QTCs before the remaining QTCs of the transform block are received as shown in step 2020, wherein N is a positive integer smaller than M. The sign bit hiding process comprises encoding a sign flag for each non-zero QTC of the scan block except for the candidate QTC. The sign bit hiding process may further comprise modifying a value-modification QTC in a selected range of QTCs of the scan block depending on the result of parity checking operation on all QTCs or all non-zero QTCs of the scan block. The sign bit hiding process may also comprise checking the distance between the first non-zero QTC and the last non-zero QTC of the scan block to determine whether to modify a value-modification QTC by a modification value. The modification value may be +1 or −1. To achieve the minimum cost of compensation for SBH, the value-modification QTC may be identified according to the minimum cost function within the selected range. The cost function is related to quantization distortion due to value modification associated with the corresponding QTC. The selected range of value-modification QTCs corresponds to one of the ranges described above in methods A to G associated with FIG. 16 or other selected range of the scan block.

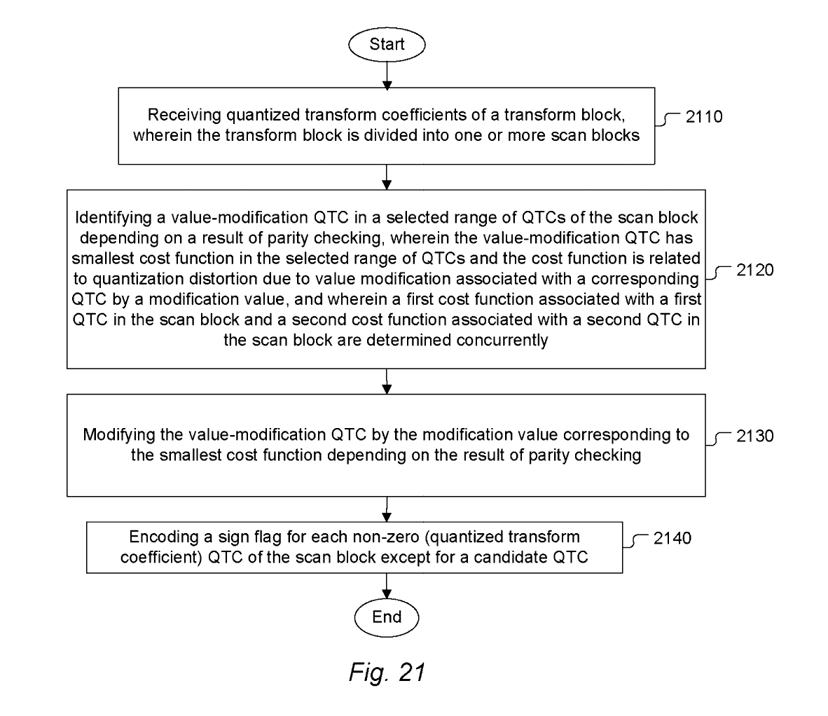

FIG. 21 illustrates an exemplary flowchart of processing transform coefficients and modifying a QTC for a video coder incorporating an embodiment of the present invention. As described before, when SBH process is enabled, the sign bit of the candidate QTC is hidden. For parity checking associated with the candidate QTC, a value-modification QTC may be modified to compensate for the hidden sign bit. The best result of the compensation is to modify a value-modification QTC with the minimum cost function. According to one embodiment, quantized transform coefficients of a transform block are received from a media or a processor as shown is step 2110. The transform block is divided into one or more scan blocks. A value-modification QTC with the smallest cost function is identified in a selected range of QTCs of the scan block depending on the result of parity checking, as shown in step 2120. The cost function is related to quantization distortion due to value modification associated with the corresponding QTC by a modification value, such as +1 or −1. The first cost function associated with the first QTC in the scan block and the second cost function associated with the second QTC in the scan block are determined concurrently. The value-modification QTC is modified by the value corresponding to the smallest cost function depending on the result of parity checking of QTCs, as shown in step 2130. Then, a sign flag is encoded for each non-zero quantized transform coefficient (QTC) of the scan block except for the candidate QTC in step 2140.

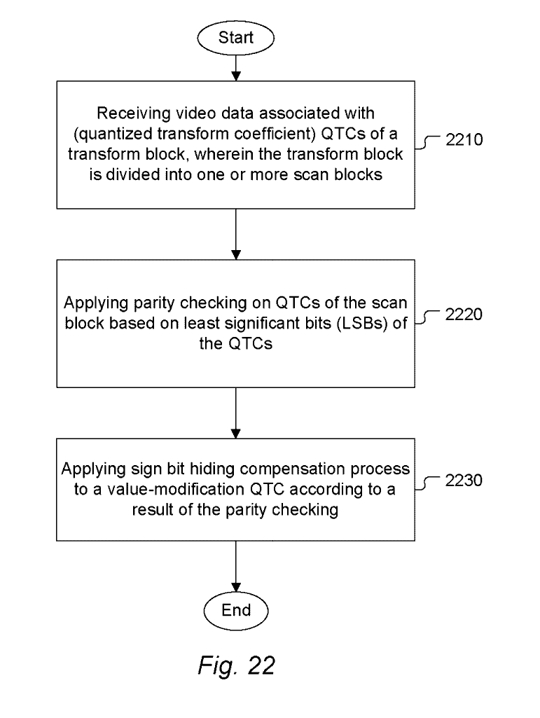

FIG. 22 illustrates an exemplary flowchart of processing transform coefficients with parity checking on QTCs for a video encoder or decoder incorporating an embodiment of the present invention. As described before, the candidate QTC is inferred from parity checking associated with other QTCs. According to one embodiment of the present invention, a method for parity checking is disclosed to improve the performance of a video coder, which reduces critical path of multiple coefficients by processing in parallel for a video coder incorporating SBH processor. According to this embodiment, video data associated with QTCs of a transform block is received from a media or a processor, wherein the transform block is divided into one or more scan blocks, as shown in step 2210. Parity checking is applied on QTCs of the scan block based on the least significant bits (LSBs) of the QTCs, as shown in step 2220. The parity checking may correspond to exclusive OR (XOR) operations on the LSBs of all QTCs of the scan block or all non-zero QTCs of the scan block. The parity checking may also correspond to perform summation operations on the LSBs of all QTCs of the scan block or all non-zero QTCs of the scan block and a modulo 2 operation on the result of the summation operations. For parity checking, SBH compensation process is applied to the candidate QTC according the result of parity checking is step 2230. The SBH compensation process in the video decoder corresponds to changing the candidate QTC to a negative value if the result of the parity checking indicates the sign bit of the candidate QTC is hidden. The SBH compensation process in the video encoder corresponds to modifying the candidate QTC by a modification value such as +1 or −1.

The exemplary flowcharts shown in FIG. 20 through FIG. 22 are for illustration purpose. The two flowcharts in FIG. 20 and FIG. 21 can also be used for image processing. A skilled person in the art may re-arrange, combine steps or split a step to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

What is claimed is:

1. A method of processing transform coefficients for a video encoder or an image processor, the method comprising:
receiving one or more quantized transform coefficients (QTCs) of a transform block, wherein the transform block consists of M QTCs, M is a first positive integer, and the transform block is divided into one or more scan blocks; and
applying sign bit hiding process on N QTCs before remaining QTCs of the transform block are received, wherein N is a second positive integer smaller than M and said sign bit hiding process comprises encoding a sign flag for each non-zero quantized transform coefficient (QTC) of the scan block except for a candidate QTC.

2. The method of claim 1, wherein said sign bit hiding process further comprises modifying a value-modification QTC in a selected range of QTCs of the scan block by a modification value depending on a result of parity checking, if said modifying the value-modification QTC is enabled.

3. The method of claim 2, wherein the modification value corresponds to +1 or −1.

4. The method of claim 2, wherein the value-modification QTC is identified according to minimum cost function, wherein the cost function is related to quantization distortion due to value modification associated with a corresponding QTC.

5. The method of claim 2, wherein said sign bit hiding process comprises checking a distance between a first non-zero QTC and a last QTC of one scan block to determine whether to enable said modifying the value-modification QTC.

6. The method of claim 2, wherein the selected range of QTCs corresponds to a first non-zero QTC of one scan block, a last non-zero QTC of one scan block, a last QTC of one scan block, the first non-zero QTC to the last non-zero QTC of one scan block, the first non-zero QTC to the last QTC of one scan block, the last non-zero QTC to the last QTC of one scan block, or consecutive 8 QTCs of one scan block, wherein the transform block is divided into one or more scan blocks.

7. The method of claim 2, wherein a first cost function for a first zero QTC and a second cost function for a non-zero QTC of one scan block are different, or a third cost function for a second zero QTC in a first region and a fourth cost function for a third zero QTC in a second region of one scan block are different.

8. The method of claim 2, wherein said sign bit hiding process comprises computing cost functions of a first QTC and a second QTC of the scan block concurrently.

9. The method of claim 2, wherein said sign bit hiding process comprises computing cost functions of a first QTC and a second QTC concurrently, wherein the first QTC and the second QTC belong to two different scan blocks.

10. A method of processing transform coefficients for a video encoder or an image processor, the method comprising:
receiving quantized transform coefficients (QTCs) of a transform block, wherein the transform block is divided into one or more scan blocks;
identifying a value-modification quantized transform coefficient (QTC) in a selected range of QTCs of the scan block depending on a result of parity checking, wherein the value-modification QTC has smallest cost function in the selected range of QTCs and the cost function is related to quantization distortion due to value modification associated with a corresponding QTC by a modification value, and wherein a first cost function associated with a first QTC in the scan block and a second cost function associated with a second QTC in the scan block are determined concurrently;
modifying the value-modification QTC by the modification value corresponding to the smallest cost function depending on the result of parity checking; and
encoding a sign flag for each non-zero (quantized transform coefficient) QTC of the scan block except for a candidate QTC.

11. The method of claim 10, wherein a third cost function associated with a third QTC in a first scan block and a fourth cost function associated with a fourth QTC in a second scan block are determined concurrently.

12. The method of claim 11, wherein the modification value corresponds to +1 or −1.

13. The method of claim 10, wherein all zero QTCs in the scan block use a same cost function.

14. An apparatus of processing transform coefficients for a video encoder or an image processor, the apparatus comprising one or more electronic circuits, wherein said one or more electronic circuits are configured to:
receive one or more quantized transform coefficients (QTCs) of a transform block, wherein the transform block consists of M QTCs, M is a first positive integer, and the transform block is divided into one or more scan blocks; and
apply sign bit hiding process on N QTCs before remaining QTCs of the transform block are received, wherein N is a second positive integer less than M and said sign bit hiding process comprises encoding a sign flag for each non-zero QTC of the scan block except for a candidate QTC.
